(19) United States
(12) Patent Application Publication
(10) Pub. No.: US 2012/0323955 A1
(43) Pub. Date: Dec. 20, 2012

(54) RELATIONAL MODELING AND RUNTIME FOR DATE EFFECTIVE ENTITIES

(75) Inventors: Adrian Orth, West Fargo, ND (US); Xinhua Huang, Sammamish, WA (US); Amar Nalla, Redmond, WA (US); Deepak Kumar, Redmond, WA (US); Jeremy Jensen, Moorhead, MN (US); Matt Sampson, Fargo, ND (US)

(73) Assignee: MICROSOFT CORPORATION, Redmond, WA (US)

(21) Appl. No.: 13/161,266

(22) Filed: Jun. 15, 2011

(51) Int. Cl. G06F 17/30

(52) U.S. Cl. 707/769; 707/E17.014

(57) ABSTRACT

A database application may receive a database query to retrieve a relation with date effective information stored by a relational database, and send a database result having the date effective information. The database application may comprise a data mapping component to retrieve a relation definition for the relation from metadata associated with the relation, the relation definition having a relation variable with a set of attributes including multiple date effective attributes, the relation definition having a definition for an alternate key formed from a composite of a date effective attribute and one other attribute from the set of attributes, and a data access component to generate the relation with the date effective information using the alternate key, the relation having a set of one or more tuples, with each tuple having one or more attribute values for corresponding date effective attributes of the relation. Other embodiments are described and claimed.

### BACKGROUND

Commercial line-of-business applications may need to track information over a period of time. For instance, an enterprise resource planning (ERP) application may need access to an employment history for an employee, such as past positions or future contact information. To accomplish this, commercial line-of-business applications are commonly customized as part of their deployment to fit them to the needs of that particular business. A common customization is to add new data fields to existing tables within a database. However, such customizations become more complex when adding temporal fields to existing tables. It is with respect to these and other considerations that the present improvements have been needed.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

Various embodiments are generally directed to techniques to manage information stored in a database having a time component. Some embodiments are particularly directed to techniques to access date effective information stored in a relational database. An application, such as a commercial line-of-business application, may operate within a framework that facilitates modeling of entities, language and programmatic access to query and update date effective information, runtime support for maintaining data consistency, and user interface support.

In one embodiment, for example, an apparatus may comprise a logic device and a database application operative on the logic device. The database application may be arranged to receive a database query to retrieve a relation with date effective information stored by a relational database, and send a database result having the date effective information in response to the database query. The database application may comprise, for example, a data mapping component operative to retrieve a relation definition for the relation from metadata associated with the relation, the relation definition having a relation variable with a set of attributes including multiple date effective attributes, the relation definition having a definition for an alternate key formed from a composite of a date effective attribute and one other attribute from the set of attributes. The database application may further comprise a data access component operative to generate the relation with the date effective information using the alternate key, the relation having a set of one or more tuples, with each tuple having one or more attribute values for corresponding date effective attributes of the relation. Other embodiments are described and claimed.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates an embodiment of a relational database management system (RDBMS) 100.

FIG. 2 illustrates an embodiment of a relation definition for a RDBMS.

FIG. 3 illustrates an embodiment of a relation for a RDBMS.

FIG. 4 illustrates an embodiment of a first implementation for a relation definition of a RDBMS.

FIG. 5 illustrates an embodiment of an implementation for a relation in accordance with the relation definition of FIG. 4.

FIG. 6 illustrates an embodiment of a second implementation for a relation definition of a RDBMS.

FIG. 7 illustrates an embodiment of a third implementation for a relation definition of a RDBMS.

FIG. 8 illustrates an embodiment of a fourth implementation for a relation definition of a RDBMS.

FIG. 9A illustrates an embodiment of a fifth implementation for a relation definition of a RDBMS.

FIG. 9B illustrates an alternate embodiment of a fifth implementation for a relation definition of a RDBMS.

FIG. 10 illustrates an embodiment of an implementation for a relation in accordance with the relation definition of FIG. 9B.

FIG. 11A illustrates an embodiment of a sixth implementation for a relation definition of a RDBMS.

FIG. 11B illustrates an alternate embodiment of a sixth implementation for a relation definition of a RDBMS.

FIG. 12A illustrates an embodiment of a seventh implementation for a relation definition of a RDBMS.

FIG. 12B illustrates an alternate embodiment of a seventh implementation for a relation definition of a RDBMS.

FIG. 13 illustrates an embodiment of an implementation for a relation in accordance with the relation definition of FIG. 12B.

FIG. 14 illustrates an embodiment of a centralized system for the system of FIG. 1.

FIG. 15 illustrates an embodiment of a distributed system for the system of FIG. 1.

FIG. 16 illustrates an embodiment of a logic flow.

FIG. 17 illustrates an embodiment of a computing architecture.

FIG. 18 illustrates an embodiment of a communications architecture.

### DETAILED DESCRIPTION

Various embodiments are generally directed to framework improvements for a relational database. A relational database matches data by using common characteristics found within a data set. For example, a data set containing information for all employees for a company can be grouped by a business unit, a product, a position, and so forth. Such a grouping uses a relational model, sometimes referred to as a logical schema, and hence a reason for the term “relational database.” Software used to do this grouping is called a relational database management system (RDBMS), and the term “relational database” often refers to this type of software.

Various embodiments are particularly directed to model driven techniques to manage date effective information stored by a relational database. The term “date effective information” generally refers to information or data elements of a relational database that have an associated time component, time dimension or temporal data element, such as a date, a time, a date and time, and so forth. A relational model may be built and used to define temporal data elements for a relational database. This model driven approach may better control how date effective information is entered, updated, managed, and accessed for a given RDBMS. As a result, the embodiments can improve affordability, scalability, modularity, extendibility, or interoperability for an operator, device or network.

A relational database using model driven techniques to manage date effective information may be useful in many ways. An enhanced relational database may be designed to support modeling of entities, language and programmatic access to query and update date effective information, and runtime support for maintaining data consistency. Different applications, such as a commercial line-of-business application, may be designed to interact with the enhanced relational database to access date effective information. For instance, a human resources director may use an ERP application to interact with a relational database to retrieve different types of related information for an employee, such as a past position for an employee on a given date, a current salary for an employee on a current date, or new contact information for a departing employee sometime at a future date. Changes to a relation may be implemented by modifying the associated relation model.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

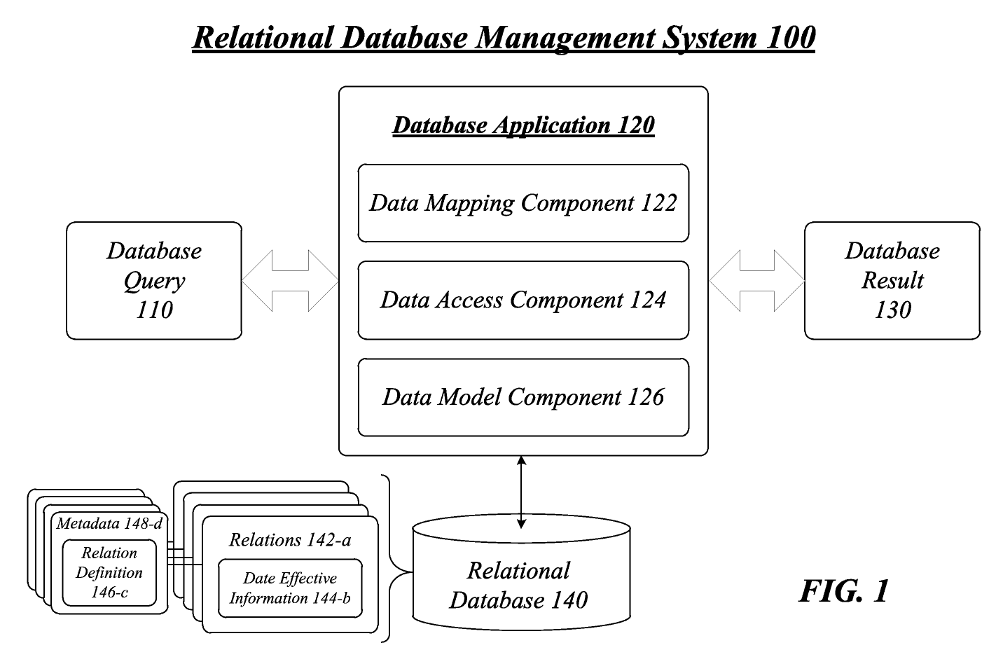

FIG. 1 illustrates a block diagram for a relational database management system (RDBMS) 100. In one embodiment, the RDBMS 100 may comprise a computer-implemented RDBMS 100 having one or more software applications and/or components. Although the RDBMS 100 shown in FIG. 1 has a limited number of elements in a certain topology, it may be appreciated that the RDBMS 100 may include more or less elements in alternate topologies as desired for a given implementation.

The RDBMS 100 is a database management system that is based on a relational model. A relational model for database management is a database model based on first-order predicate logic. The relational model describes a database as a collection of predicates over a finite set of predicate variables, describing constraints on the possible values and combinations of values. A predicate is a statement that may be true or false depending on a current value of its variables. The content of the database at any given time is a finite (logical) model of the database, for example, a set of relations, one per predicate variable, such that all predicates are satisfied.

In the embodiment shown in FIG. 1, the RDBMS 100 may comprise a database application 120. The database application 120 may generally manage information stored by a relational database 140. In one embodiment, the database application 120 and the relational database 140 may be tightly integrated within a single product, such as an Oracle® Database made by Oracle Corporation, a DB2® Database made by IBM®, a SQL Server® application made by Microsoft® Corporation, and others. Alternatively, the database application 120 and the relational database 140 may be loosely integrated in separate products.

The database application 120 may implement various processes to monitor, interact and expedite database operations with the relational database 140. Examples of such processes may include without limitation queuing processes, archiving processes, database write processes, database read processes, logging processes, memory management processes, remote file-server processes, shared server processes, system monitoring processes, security processes, and so forth. The database application 120 may comprise a stand-alone application, or may be integrated with another application. For instance, the database application 120 may be integrated with a middle-tier application, such as a commercial ERP application, customer relationship management (CRM) application, supply chain management (SCM) application, and so forth.

In general operation, the database application 120 may be arranged to receive a database query 110 to retrieve a relation 142-a with date effective information 144-b stored by the relational database 140. The database application 120 may send a database result 130 having the date effective information 144-b in response to the database query 110.

A relation 142-a may comprise a data structure having a header and a body organized into rows and columns, and as such, is frequently referred to as a “table.” A header may comprise an unordered set of certain attributes (columns). An attribute is a pair of its attribute name and domain name. Domain can be considered a data type. A header may have zero or more attributes. A body may comprise an unordered set of tuples (rows) that share the same type. A tuple is a data structure comprising an unordered set of zero or more attributes and attribute values which conform to a domain. An attribute value is an instance of an attribute. A relation 142-a may have zero or more tuples.

The database application 120 may comprise a data mapping component 122. The data mapping component 122 may be generally arranged to map entities (or objects) which correspond to data elements stored in the relational database 140. Such mappings may be defined in a relation definition 146-c. A relation definition 146-c may comprise various definitions consistent with a database model for the relational database 140, which is based on first-order predicate logic. A predicate is a statement that may be true or false depending on the values of its variables. A relation definition 146-c may comprise one or more relation variables, sometimes referred to as “relvars.” A relation variable is a variable that has a relation value. A relation value is an instance of a relation 142-a.

In one embodiment, a relation definition 146-c may have one or more relation variables with a set of attributes, with the set of attributes further including one or more date effective attributes. A date effective attribute may refer to a temporal based attribute associated with a time dimension, such as a date, a time, a date and time, and so forth. A data effective attribute may have attribute values comprising date effective information 144-b. Date effective information 144-b may comprise attribute values of a temporal data type, with the temporal data type associated with a time dimension, such as a date, a time, a date and time, and so forth.

In one embodiment, the data mapping component 122 may receive a database query 110 from an entity, parse the database query 110, and retrieve an appropriate relation definition 146-c for a relation 142-a from metadata 148-d associated with the relation 142-a. The data mapping component 122 may send, or otherwise make available, the relation definition 146-c to the data access component 124 for use in accessing relational data from the relational database 140.

The database application 120 may further comprise a data access component 124. The data access component 124 may be generally arranged to manage access to data stored in the relational database 140. The data access component 124 controls access by various entities (objects) to relational data stored by the relational database 140 using the relation definitions 146-c stored by the data mapping component 122.

In one embodiment, the data access component 124 may receive a database query 110, and generate a relation 142-a from relational data stored by the relational database 140, with the relation 142-a comprising various relation values and/or attribute values representing date effective information 144-b. More particularly, the relation 142-a may comprise a set of one or more tuples, with each tuple having one or more attribute values for corresponding date effective attributes of the relation 142-a.

The data access component 124 may generate a relation 142-a using one or more unique indices, sometimes referred to as “keys.” A key is designed to uniquely identify each tuple in a relation 142-a (e.g., row in a table). The unique key may comprise one or more attributes (e.g., one or more columns in a table). For instance, the data access component 124 may use a candidate key for a relation 142-a as defined by an associated relation definition 146-c. A candidate key of a relation 142-a is a minimal “superkey” for that relation 142-a, that is, a set of attributes such that: (1) the relation does not have two distinct tuples (e.g., rows or records in common database language) with the same values for these attributes; and (2) there is no proper subset of these attributes for which (1) holds (which means that the set is minimal). The RDBMS 100 may be designed such that each relation 142-a has at least one candidate key as a primary key, which means that it is considered as a desired way to identify individual tuples. In another example, the data access component 124 may use a foreign key for a relation 142-a as defined by an associated relation definition 146-c. A foreign key is a referential constraint between two relations 142-a. For instance, a foreign key may comprise an attribute in a relation 142-1 that matches a primary key of another relation 142-2. The foreign key can be used to cross-reference relations 142-1, 142-2.

In one embodiment, the data access component 124 may generate a relation 142-a using one or more alternate keys as defined in a relation definition 146-c. An alternate key is an alternative to a primary key that may be used to uniquely identify each tuple in a relation 142-a (e.g., row in a table). With respect to date effective information 144-b, a relation definition 146-c may include a definition for an alternate key formed from a composite of a date effective attribute and one other attribute from the set of attributes for a given relation 142-a. Different alternate keys may be selected to enforce different semantics or behavior for relations 142-a as desired for a given implementation.

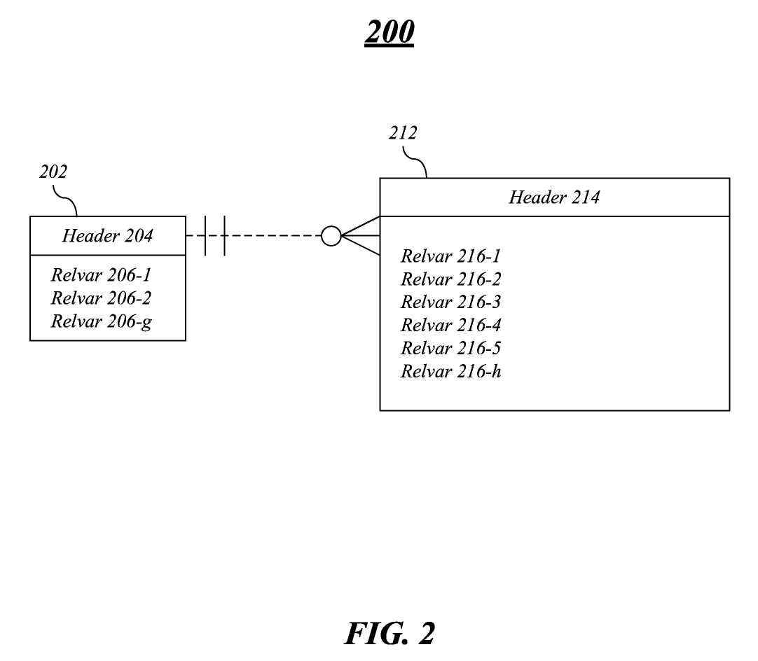

In one embodiment, a relation definition 146-c may have a definition for an alternate key formed from a composite of a date effective attribute and one or more other attributes from the set of attributes. Examples of relation definitions 146-c and relations 142-a may be described with reference to FIGS. 2-13.

The data access component 124 may retrieve or generate date effective information 144-b for a relation 142-a in accordance with a relation definition 146-c stored as part of metadata 148-d associated with each of the relations 142-a. The metadata 148-d is frequently considered part of the relational database 140, as it helps to organize and structure relational data elements, in addition to forcing the relational database 140 to conform to a set of requirements. To implement data effective information 144-b at a relation-level or table-level, the relation definition 146-c may store definitions for date effective information 144-b may be stored as part of a set of metadata 148-d associated with a given relation 142-a.

The data access component 124 may send a database result 130 with date effective information 144-b in response to the database query 110. Once the database application 120 generates a relation 142-a with date effective information 144-b in response to a database query 110, the database application 120 may send a database result 130 with the relation 142-a to the requesting entity. The relation 142-a may include, among other relational data elements, the date effective information 144-b.

The database application 120 may comprise a data model component 126. The data model component 126 may be arranged to define one or more relation definitions 146-c for a relation 142-a, and store the relation definition 146-c with metadata 148-d for the relation 142-a. The relation definition 146-c may have a relation variable with a set of attributes including multiple date effective attributes. The date effective attributes may include, for example, a valid from (ValidFrom) attribute and a valid to (ValidTo) attribute. The relation definition 146-c may further have a definition for an alternate key formed from a composite of the valid from attribute and one other attribute from the set of attributes. In one embodiment, the other attribute can be any attribute other than the valid to attribute.

FIG. 2 illustrates a logical diagram 200 of an exemplary relational model for the RDBMS 100. More particularly, the logical diagram 200 illustrates two relation definitions 202, 212 for the RDBMS 100. Relation definitions 202, 212 may be representative of, for example, a relation definition 146-c. In the illustrated embodiment shown in FIG. 2, a relation definition 202 may comprise a header 204 and one or more relation variables, such as one or more relvars 206-g. Similarly, a relation definition 212 may comprise a header 214 and one or more relvars 216-h. Each relvar 206-g, 216-h is a variable that has a relation value. A relation value is an instance of a relation 142-a.

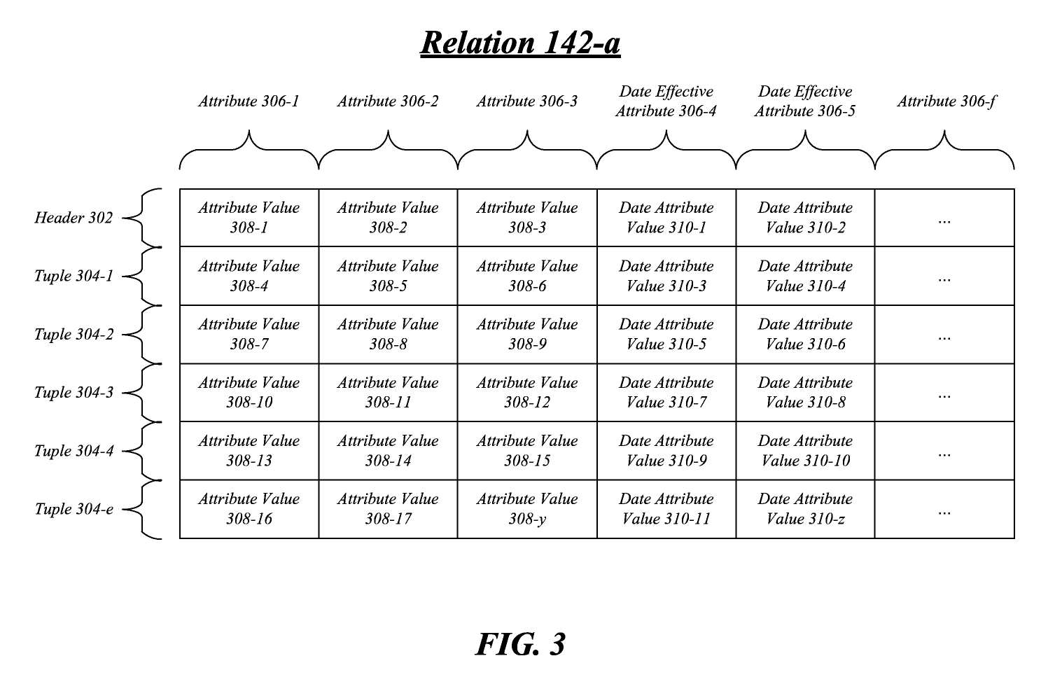

FIG. 3 illustrates a logical diagram 300 of an exemplary relational model for the RDBMS 100. More particularly, the logical diagram 200 illustrates a logical diagram 300 of a relation 142-a for the RDBMS 100. In the illustrated embodiment shown in FIG. 3, a relation 142-a may comprise a data structure having a header 302. The header 302 may comprise an unordered set of certain attributes 306-f, shown in the logical diagram 300 as columns for a table. As shown, the header 302 may include attributes 306-1, 306-2, 306-3. The header 302 may also include two date effective attributes, including date effective attributes 306-4, 306-5. It may be appreciated that a relation 142-a may comprise zero or more attributes 306-f for any given implementation.

The logical diagram 300 also shows relation 142-a comprising an unordered set of tuples 304-e, shown in the logical diagram 300 as rows for the table. In one embodiment, the tuples 304-e are all of the same data type. A tuple 304-e is a data structure comprising an unordered set of zero or more attributes 306-f and attribute values 308-z which conform to a domain. An attribute value 308-y is an instance of an attribute 306-f. A date attribute value 310-z is an instance of a date effective attribute, such as date effective attributes 306-4, 306-5, for example. It may be appreciated that a relation 142-a may comprise zero or more tuples 304-e for any given implementation.

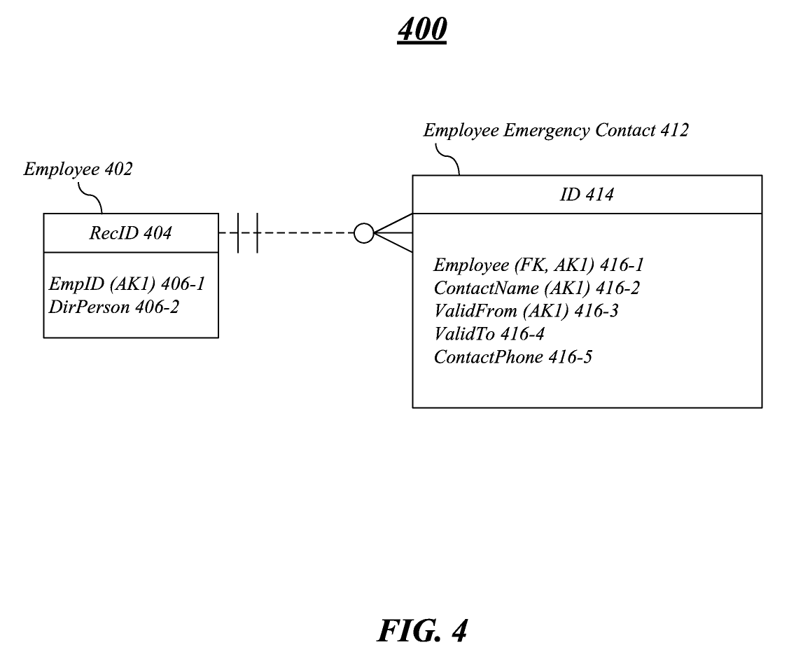

FIG. 4 illustrates a logical diagram 400 of an exemplary relational model for the RDBMS 100. More particularly, the logical diagram 400 illustrates various relation definitions 402, 412 for the RDBMS 100. Relation definitions 402, 412 may be representative of, for example, implementations of relation definitions 202, 212 as described with reference to FIG. 3. In this exemplary scenario, the relation definitions 402, 412 may be used to track a history of contact information by employee. The relation definition 412 comprises, among other elements, date effective attributes for date effective information 144-b.

The RDBMS 100 implements techniques for modeling of date effective entities at a relation (or table) level. A relation 142-a is marked as being date effective using an attribute and/or property in a relation definition 146-c. The relation definition 146-c is stored in corresponding metadata 148-d for the relation 142-a, and is used during runtime of the RDBMS 100. In one embodiment, each date effective relation 142-a may have two attributes (columns) named ValidFrom and ValidTo. In this embodiment, these two attributes can be either of data type Date or of data type DateTime. If the Date type is chosen then the granularity level of the period is at a day level and records are effective starting from the ValidFrom date to the ValidTo date both inclusive. If the DateTime type is chosen then the granularity level of the period is at a level of seconds and there can be multiple records that are valid within a given day. It may be appreciated that these are merely examples, and any level of time granularity may be used for a given implementation. The embodiments are not limited in this context.

In addition to the fields each date effective relation 142-a may have at least one alternate key which is implemented as a unique index in the relational database 140. In one embodiment, the alternate key may be referred to as a “valid time state key” and it is used to enforce time period semantics that are enabled by a date effective relation 142-a. The valid time state key may have the ValidFrom attribute and at least one other column other than ValidTo attribute as part of the alternate key. The valid time state key also has another attribute and/or property to indicate whether gaps (e.g., missing records for a period of time) are allowed in the data.

In the illustrated embodiment shown in FIG. 4, the logical diagram 400 may comprise two relation definitions for an employee of a business. As shown in the logical diagram 400, the relation definitions are related.

The first relation definition is an employee relation definition 402. The employee relation definition 402 may comprise a record identifier (RecID) 404, and two relvars comprising an employee identifier (EmpID) relvar 406-1 and a person (DirPerson) relvar 406-2. One alternate key (AK1) for employee relation definition 402 is defined using the employee identifier relvar 406-1.

The second relation definition is a date effective relation definition comprising an employee emergency contact relation definition 412. The employee emergency contact relation definition 412 may comprise an identifier (ID) 414, and five relvars comprising an employee (Employee) relvar 416-1, a contact name (ContactName) relvar 416-2, a valid from (ValidFrom) relvar 416-3, a valid to (ValidTo) relvar 416-4, and a contact phone (ContactPhone) relvar 416-5. One alternate key (AK1) for the employee emergency contact relation definition 412 is a composite of the employee 416-1, contact name 416-2, and valid from 416-3. This alternate key is a valid time state key. The employee relvar 416-1 is a foreign key (FK).

A user, such as an application developer or database manager, may use the data model component 126 to define the relation definitions 402, 412 via an appropriate user interface, and store the relation definitions 402, 412 as part of metadata 148-d in the relational database 140. When a database query 110 is received by the database application 120, the data mapping component 122 may retrieve the relation definitions 402, 412, and forward them to the data access component 124. Alternatively, the data access component 124 may handle the database query 110 and request the relation definitions 402, 412 from the data mapping component 122. In both cases, the data access component 124 may use the relation definitions 402, 412 to generate a relation 142-a.

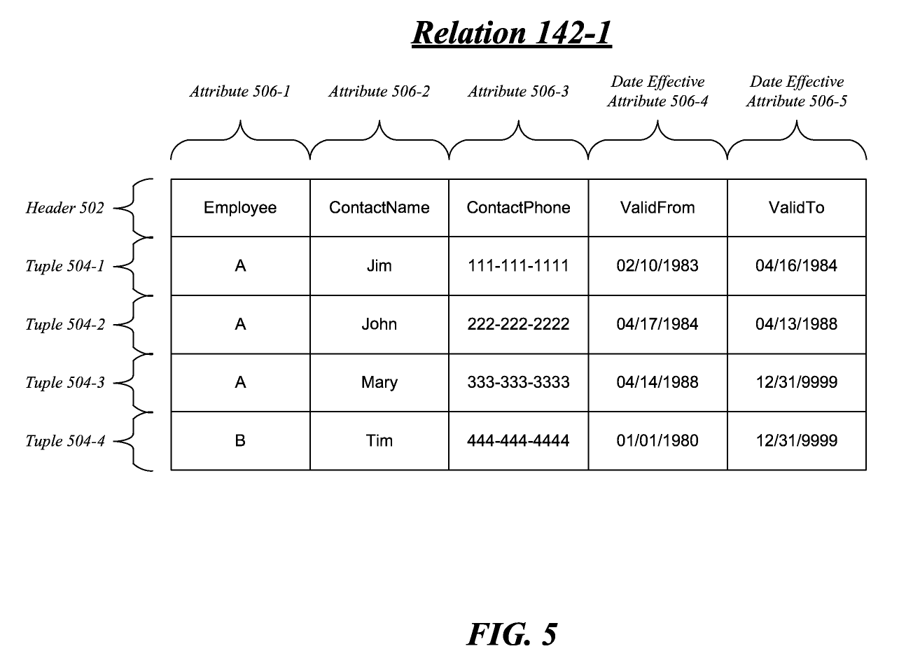

FIG. 5 illustrates a relation 142-1 populated with relation values and generated using the relation definitions 402, 412 as described with reference to FIG. 4. In the illustrated embodiment shown in FIG. 5, the relation 142-1 may comprise five attributes 506-1 to 506-5 matching those provided in the employee emergency contact relation definition 412 (unordered), with the attributes 506-4, 506-5 comprising date effective attributes 506-4, 506-5. The relation 142-1 may further comprise a header 502 having attribute names for the attributes 506-1 to 506-5 matching those provided in the employee emergency contact relation definition 412 (unordered). The relation 142-1 also has four tuples 504-1 to 504-4, with each tuple 504-1 to 504-4 having a sample relation value for each of the attributes 506-1 to 506-5.

In the relation 142-1, an Employee A has three tuples 504-1, 504-2 and 504-3 (e.g., records) that reflect changing contact names (e.g., Jim, John and Mary) over a period of time. Therefore, using a primary key alone (e.g., attribute 506-1 for Employee) would not uniquely identify relation values for each tuple 504-1, 504-2 and 504-3. As such, the relation 142-1 uses a unique index to generate the tuples 504-1, 504-2 and 504-3 in a form of an alternate key having a composite of the attribute 506-1 (Employee) and the date effective attribute 506-4 (ValidFrom). This alternate key is a valid time state key. Additionally, the valid time state key may include the date effective attribute 506-5 (ValidTo) as part of the unique index, however, this implementation is optional.

In this example, the alternate key is considered a valid time state key for the relation 142-1. Since it is a desirable to track a history for each Employee, the attribute 506-1 used to represent the Employee is made part of the valid time state key. Hence the valid time state key enables the RDBMS 100 to indicate a field for which the history is being tracked.

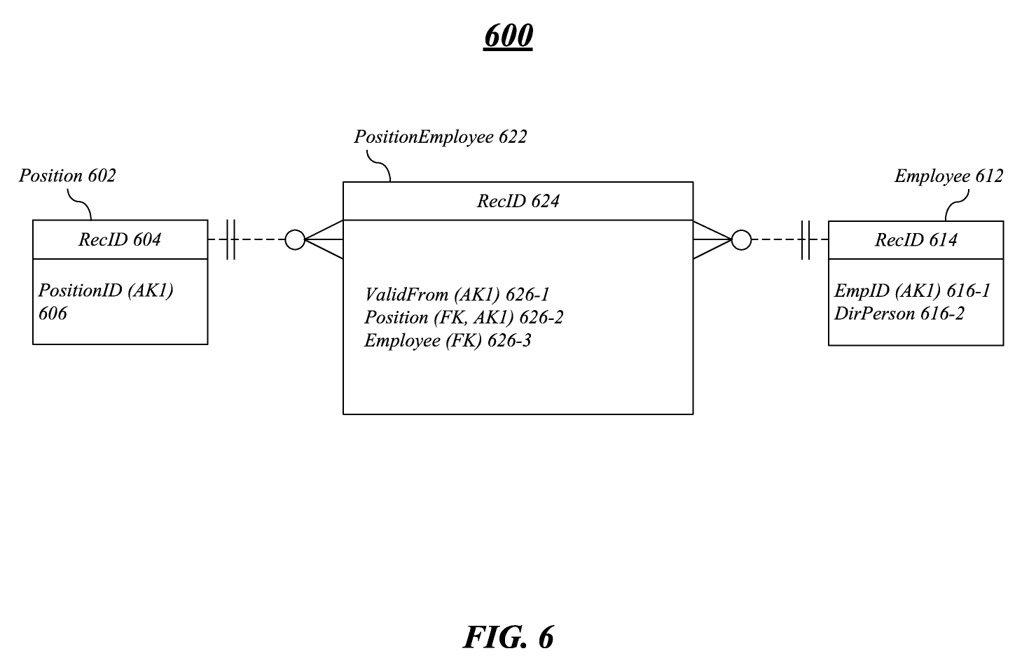

In this particular scenario, assume there is a constraint implemented for relation 142-1 to not allow any gap in contact information for a given employee, and this is specified as a property in metadata for the valid time state key. Alternatively, other scenarios may tolerate gaps in contact information, and this could also be specified using a same property in the key metadata. Further assume that the RDBMS 100 also enforces that an employee cannot have more than one contact at a same time. This would prevent overlaps in the data that could potentially render the data inconsistent. Additional details on the design of a valid time state key and the role it plays in enforcing date effective semantics is described further with reference to FIGS. 6-16.

It is worthy to note that relation values for attributes 506-1 to 506-5 may be used to enforce certain date effective semantics as well. For instance, if the date effective attribute 506-5 (ValidTo) has a maximum value allowed then it indicates that this particular record does not expire. This is merely one example, and others may be implemented as well.

FIG. 6 illustrates a logical diagram 600 of an exemplary relational model for the RDBMS 100. More particularly, the logical diagram 600 illustrates various relation definitions for an employee of a business. As shown in the logical diagram 600, the relation definitions are related to each other.

The first relation definition is an employee position definition 602. The employee position definition 602 may comprise a record identifier (RecID) 604, and a single relvar comprising a position identifier (PositionID) relvar 606. The position identifier relvar 606 is an alternate key (AK1) for the employee position definition 602.

The second relation definition is an employee relation definition 612. The employee relation definition 612 may comprise a record identifier (RecID) 614, and two relvars comprising an employee identifier (EmpID) relvar 616-1 and a person (DirPerson) relvar 616-2. One alternate key (AK1) for the employee relation definition 612 is the employee identifier relvar 616-1.

The third relation definition is a date effective relation definition comprising a position employee relation definition 622. The position employee relation definition 622 may comprise a record identifier (RecID) 624, and three relvars comprising a valid from (ValidFrom) relvar 626-1, a valid to (ValidTo) relvar 626-2, a position (Position) relvar 626-3, and an employee (Employee) relvar 626-4. One alternate key (AK1) for the position employee relation definition 412 is a composite of the valid from relvar 626-1 and the position relvar 626-3. This alternate key is a valid time state key. The position relvar 626-3 and employee relvar 626-4 are foreign keys (FK). This particular model enables tracking of changes in employees for a particular position over a period of time. Employee will be changing for a Position so it is not part of the alternate key. However, it may be appreciated that an alternate model may be implemented where the Employee is part of the alternate, but the Position is not. The embodiments are not limited in this context.

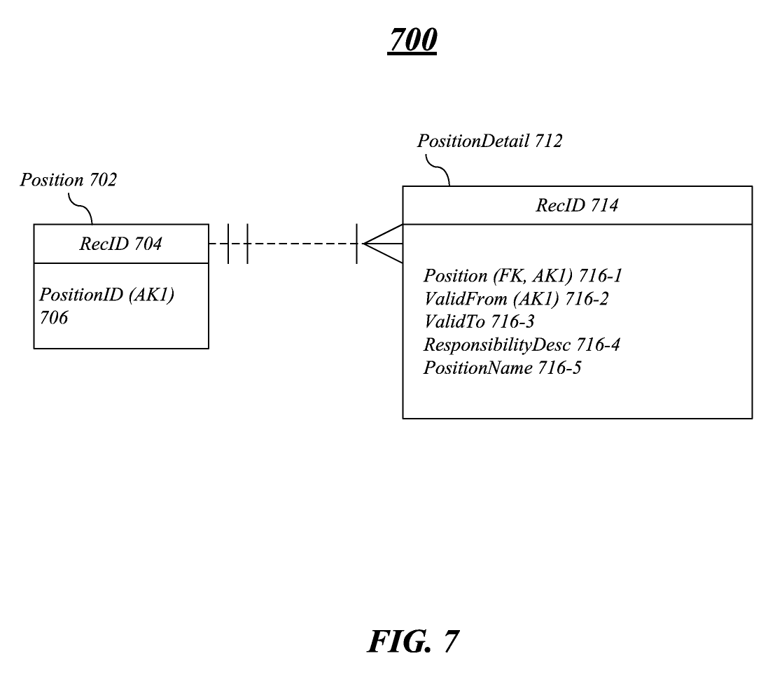

FIG. 7 illustrates a logical diagram 700 of an exemplary relational model for the RDBMS 100. More particularly, the logical diagram 700 illustrates various relation definitions for an employee of a business. As shown in the logical diagram 700, the relation definitions are related to each other.

The first relation definition is an employee position definition 702. The employee position definition 702 may comprise a record identifier (RecID) 704, and a single relvar comprising a position identifier (PositionID) relvar 706. The position identifier relvar 706 is an alternate key (AK1) for the employee position definition 702.

The second relation definition is a position detail relation definition 712. The position detail relation definition 612 may comprise a record identifier (RecID) 714, and five relvars comprising a position (Position) relvar 716-1, a valid from (ValidFrom) relvar 716-2, a valid to (ValidTo) relvar 716-3, a responsibility description (ResponsibilityDesc) relvar 716-4, and a position name (PositionName) relvar 716-5. One alternate key (AK1) for the position detail relation definition 712 is a composite of the position relvar 716-1 and the valid from relvar 716-2. This alternate key is a valid time state key.

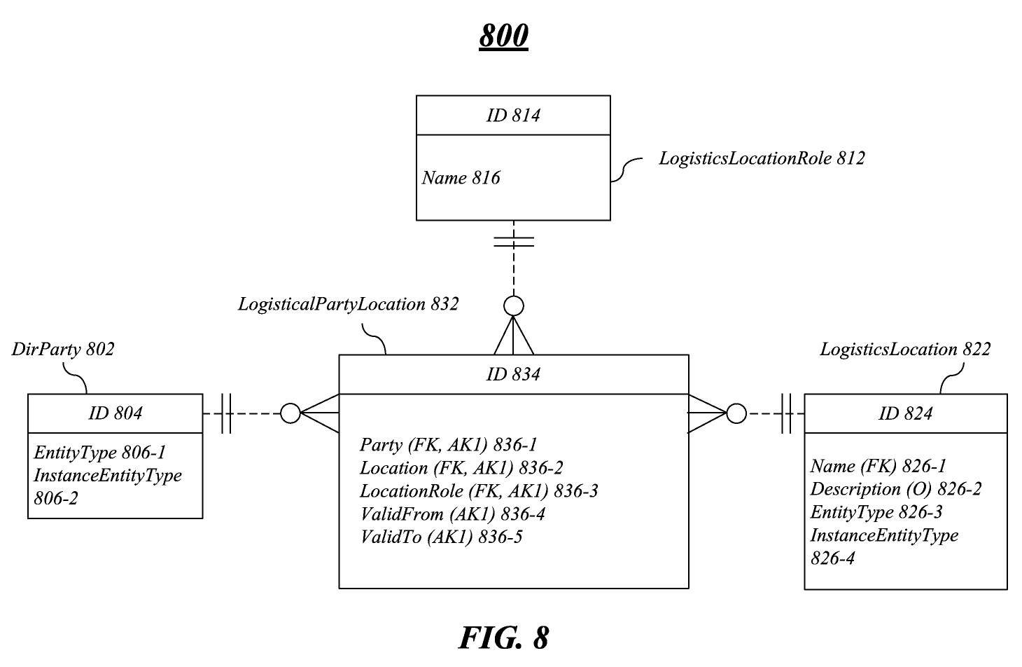

FIG. 8 illustrates a logical diagram 800 of an exemplary relational model for the RDBMS 100. More particularly, the logical diagram 800 illustrates various relation definitions for an employee of a business. As shown in FIG. 8, the relation definitions are related to each other in a ternary relationship pattern. However, it may be appreciated that other embodiments may have any number of N-ary relationship patterns, where N represents any positive integer (e.g., binary, ternary, 4-ary, and so forth)

The first relation definition is a party (DirParty) relation definition 802. The party relation definition 802 may comprise an identifier (ID) 804, and two relvars comprising an entity type (EntityType) relvar 806-1 and an instance entity type (InstanceEntityType) relvar 806-2.

The second relation definition is a logistics location role (LogisticsLocationRole) relation definition 812. The logistics location role relation definition 812 may comprise an identifier (ID) 814, and a single relvar comprising a name (Name) relvar 816.

The third relation definition is a logistics location (LogisticsLocation) relation definition 822. The logistics location relation definition 822 may comprise an identifier (ID) 824, and four relvars comprising a name (Name) relvar 826-1, a description (Description) relvar 826-2, an entity type (EntityType) relvar 826-3, and an instance entity type (InstanceEntityType) relvar 826-4. The name relvar 826-1 is a foreign key (FK).

The fourth relation definition is a date effective relation definition comprising a logistical party location (LogisticsPartyLocation) relation definition 832. The logistics party location relation definition 832 may comprise an identifier (ID) 834, and five relvars comprising a party (Party) relvar 836-1, a location (Location) relvar 836-2, a location role (LocationRole) relvar 836-3, a valid from (ValidFrom) relvar 836-4, and a valid to (ValidTo) relvar 836-5. The party relvar 836-1, the location relvar 836-2 and the location role relvar 836-3 are all foreign keys (FK). The party relvar 836-1 and the valid from relvar 836-4 may comprise a first composite alternate key (AK). Additionally or alternatively, the location relvar 836-2 and the valid from relvar 836-4 may comprise a second composite alternate key. The valid to relvar 836-5 may comprise an optional addition to the first or second composite alternate keys (AK). One or more of these alternate keys may be implemented as a valid time state key.

In addition to providing a unique index for a relation 142-a, the valid time state key may be used to control modifications to a relation 142-a. The database application 120 may be used to modify date effective information 144-b for a relation 142-a stored by the relational database 140 in accordance with a given relation definition 146-c. In some cases, modifications to a relation 142-a and its relational values need to be made within a given set of design constraints, rules, conditions, or semantics.

In one embodiment, for example, the database application 120 may be used to modify date effective information for a relation 142-a stored by the relational database 140 in accordance with one or more update conditions, including an overlap condition or a gap condition. An overlap condition is where an entity cannot have overlapping periods of time for a given attribute. A gap condition is where an entity cannot have missing periods of time for a given attribute. The overlap and gap conditions to ensure valid date effective implementation for a relation 142-a can be enforced using one or more property values specified in a valid time state key used to ensure an attribute (column) uniquely identifies a tuple (row).

To ensure runtime support for data consistency for date effective information 144-b stored by the relational database 140, the RDBMS 100 needs to ensure that the data associated with a relation 142-a is consistent with a given set of overlap and gap semantics. Since data that is stored in a relation 142-a can be changed and new data can be added, the RDBMS 100 always ensures that the above consistency requirements are enforced. These consistency requirements can be enforced by making adjustments to other records using an enforcement algorithm. An example of an enforcement algorithm is provided as follows:
1. If ValidFrom is being updated to be 1 less than its current value, then retrieve the previous record and update the ValidTo of the previous record to ValidFrom −1 only if it is necessary to avoid an overlap of dates. If the ValidFrom of the edited record is less than the ValidFrom of the previous record then give an error. The error will trigger deletion of the previous record to avoid overlaps and the enforcement algorithm does not automatically delete records during adjustments.
2. If ValidTo is being updated to be 1 greater than its current value, then retrieve the next record and update the ValidFrom of the next record to a ValidTo +1 value only if it is necessary to avoid an overlap of dates. If the ValidTo of the edited record is greater than the ValidTo of the next record then give an error.
3. The enforcement algorithm does not allow simultaneous editing of ValidFrom and ValidTo columns.
4. Depending on a given implementation, the enforcement algorithm may not allow editing of any other columns that are part of the valid time state key.
5. When a new record is inserted, the ValidTo of the existing record is updated to a ValidFrom −1 value of the newly inserted record only if necessary to avoid an overlap of dates. New records cannot be inserted in the past or future if there are already additional records existing for that time period.
6. When a record is deleted, the ValidTo of the previous record is adjusted to a ValidFrom −1 value of the next record if the RDBMS 100 indicates that there should be no gaps in data. If gaps in data are allowed then an adjustment is not performed.
   It may be appreciated that this is merely one example of a suitable enforcement algorithm for the RDBMS 100, and other enforcement algorithms may be used as desired for a given implementation. The embodiments are not limited in this context.

The database application 120 may be used to modify date effective information for a relation 142-a stored by the relational database 140 in accordance with one or more update modes, including a correction mode, a new time mode, or an effective based mode. The database application 120 allows regular updates of records in relations 142-a having date effective information 144-b, and it also provides additional modes that are typical for the type of changes that are done to such relations 142-a. In one embodiment, there are three update modes, including a correction mode, a new time mode, or an effective based mode.

In a correction mode, updates are made to a relation 142-a using operations similar to regular update operations made to a typical relation. If the ValidFrom or ValidTo attributes are updated, the database application 120 may update additional records to guarantee that there are no gaps or overlaps in the data.

In a new time mode, the database application 120 creates a new record with updated values and updates the ValidTo of the edited record to ValidFrom −1 of the newly inserted record. By default the ValidFrom attribute of the newly inserted record will have a current date for a Date data type or a current time for a DateTime data type. The new time mode does not allow editing of records in the past. The new time mode hides the date effectiveness of the data from an end user. The end user edits the records as usual but internally a new record is created to enable a tracking history of changes to a record.

In an effective based mode, the database application 120 implements a hybrid of the correction and new time modes. For instance, records in the past are prevented from being editing. Current active records are available for editing with the same semantics as the new time mode. Records in the future are updated using the same semantics as the correction mode.

The database application 120 may implement user interface support to handle notifications and refresh of data after changes to data in a relation 142-a. For instance, when a user updates a record in a relation 142-a having date effective information 144-b, other records might get updated in the backend. The database application 120 first provides a user interface dialog to the user informing her of the additional updates and asking if she wants to proceed. This can be achieved by simulating user actions without actually updating the data and determining if additional records will be updated. Once the user updates the data, the database application 120 refreshes the user interface with the updates by fetching all the updated records in a single roundtrip from the relational database 140.

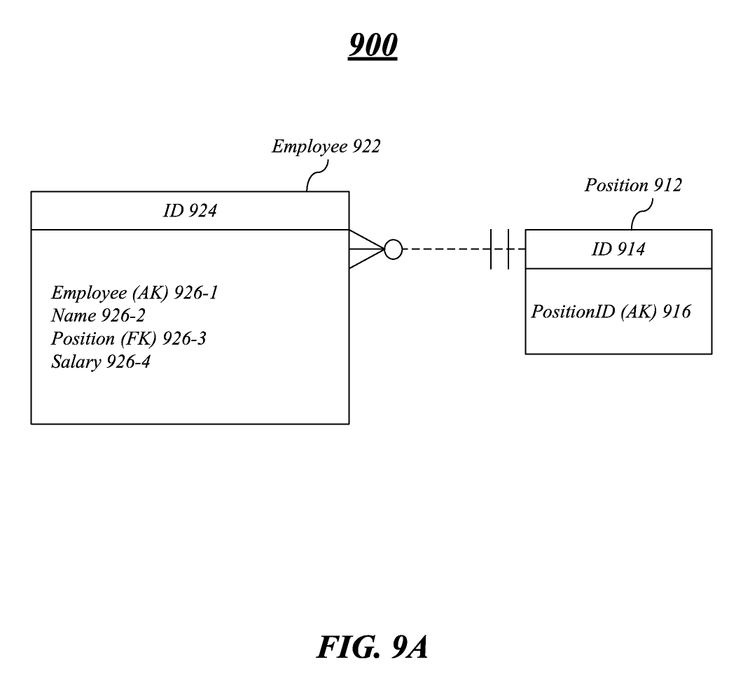

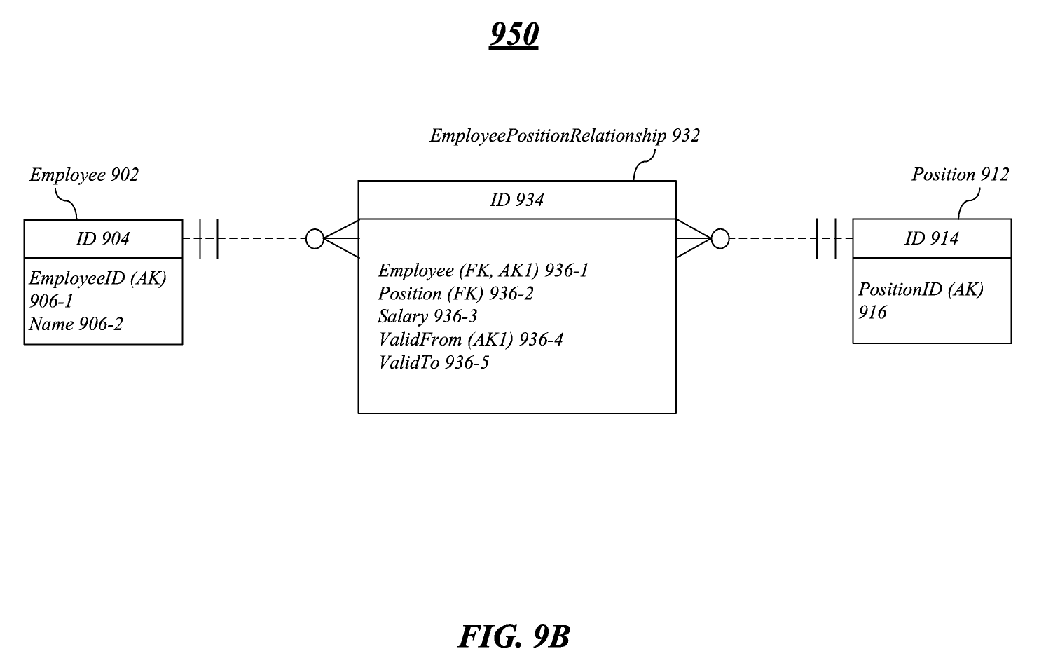

FIGS. 9A, 9B illustrate respective logical diagrams 900, 950 of exemplary relational models for the RDBMS 100. The logical diagrams 900, 950 may be used to demonstrate a first example of a design for a valid time state key and its role in enforcing date effective semantics.

The logical diagrams 900, 950 may illustrate a use scenario for enforcing overlap semantics for a relation 142-a. In this use scenario, assume a human resources manager is tracking histories for a set of employees. Further assume an employee can have only one position at a time but one position can be occupied by multiple employees. In a current database (with no history) this could be represented by the logical diagram 900.

The logical diagram 900 illustrates relation definitions without any date effective relvars. As shown, an employee relation definition 922 comprises an identifier (ID) 904, and four relvars comprising an employee (Employee) relvar 906-1, a name (Name) relvar 906-2, a position (Position) relvar 906-3, and a salary (Salary) relvar 906-4. A position relation definition 912 comprises an identifier (ID) 914, and a single relvar comprising a position identifier (PositionID) relvar 916. The relation definitions 912, 922 do not define a relation 142-a having any date effective information 144-b. Neither the employee relation definition 922 nor the position relation definition 912 provides any historical (time-based) information for an employee.

The logical diagram 950 illustrates relation definitions with date effective relvars. As shown, an employee relation definition 902 comprises an identifier (ID) 904, and two relvars comprising the employee (Employee) relvar 906-1 and the name (Name) relvar 906-2. An employee position relationship (EmployeePositionRelationship) relation definition 932 comprises an identifier (ID) 934, and five relvars comprising an employee (Employee) relvar 936-1, a position (Position) relvar 936-2, a salary (Salary) relvar 936-3, a valid from (ValidFrom) relvar 936-4, and a valid to (ValidTo) relvar 936-5. The employee position relationship relation definition 932 does provide historical (time-based) information for an employee.

The employee position relationship relation definition 932 has an alternate key (AK1) comprising a composite of the employee relvar 936-1 and the valid from relvar 936-4. This alternate key is a valid time state key that can be used to enforce overlap and gap semantics. The valid time state key prevents an employee from having two positions starting at a same date, which prevents an overlap condition from occurring. This will be enforced by the data access component 124 as part of the valid time state semantics when using the valid time state key. In this manner, the employee position relationship relation definition 932 can be used to track a history for a particular employee as her position and salary changes over time while enforcing the overlap condition.

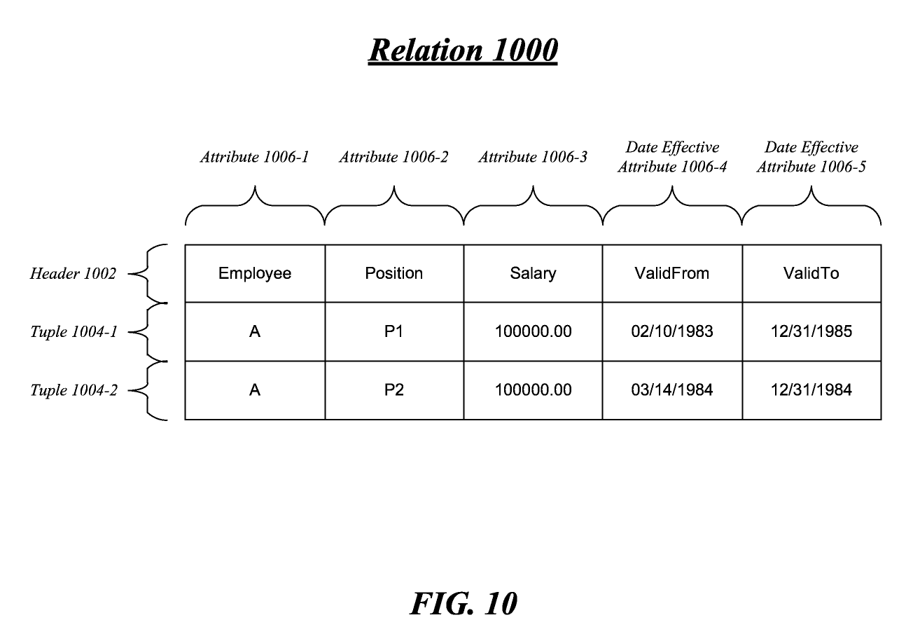

FIG. 10 illustrates a relation 1000 with sample data that is invalid for the employee position relationship relation definition 932 described with reference to the logical diagram 950 of FIG. 9B. As shown, the relation 1000 comprises attributes 1006-1 to 1006-5, with attributes 1006-4, 1006-5 comprising date effective attributes. The relation 1000 further comprises a header 1002 with attribute names for each attribute 1006-1 to 1006-5, including “Employee,” “Position,” “Salary,” “ValidFrom,” and “ValidTo.” In the sample relation values provided for each attribute 1006-1 to 1006-5 of tuples 1004-1, 1004-2, Employee A has both positions P1, P3 in an overlapping period [1984-03-14, 1984-12-31] which violates the overlap condition. The valid time state key defined by the employee position relationship relation definition 932 would prevent this overlapping scenario from occurring.

With respect to a gap condition, assume the employee position relationship relation definition 932 allows gaps. In this case, an employee could occupy a position for some time period, have no position for a contiguous time period, and later again have a position. If gaps are not allowed, however, then an employee needs to have a position at all times with no gaps in time between positions. The valid time state key defined by the employee position relationship relation definition 932 would prevent this gap scenario from occurring.

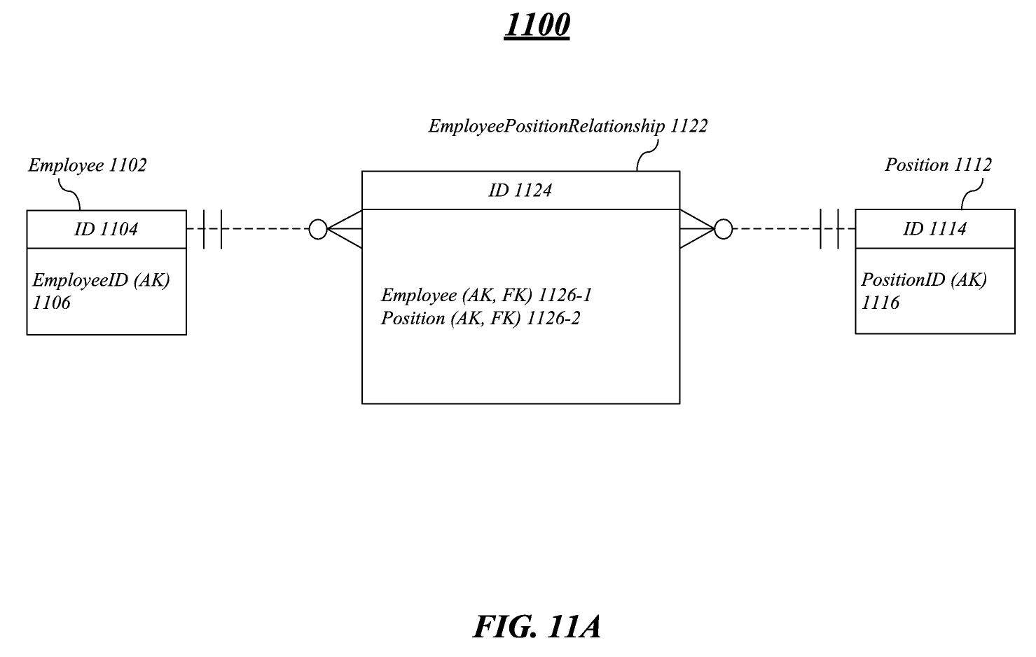

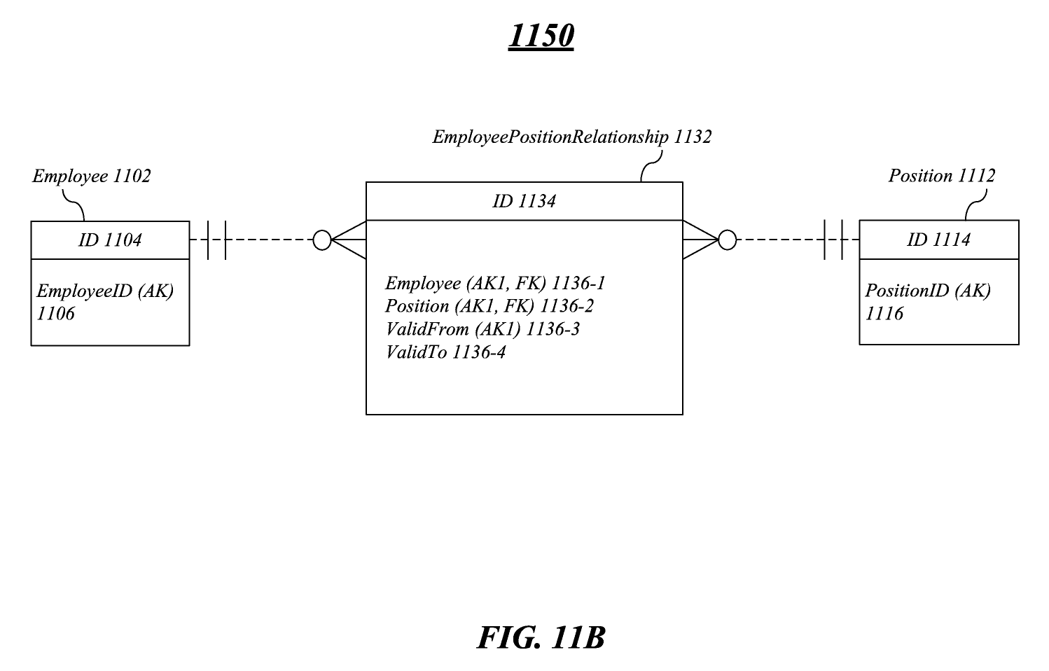

FIGS. 11A, 11B illustrate respective logical diagrams 1100, 1150 of exemplary relational models for the RDBMS 100. The logical diagrams 1100, 1150 may be used to demonstrate a second example of a design for a valid time state key and its role in enforcing date effective semantics.

The logical diagrams 1100, 1150 may illustrate a use scenario for enforcing overlap semantics for a relation 142-a. In this use scenario, assume a human resources manager is tracking histories for a set of employees. Further assume an employee can have zero or more positions and a position can have zero or more employees at a same time. In a current database (with no history) this could be represented by the logical diagram 1100.

The logical diagram 1100 illustrates relation definitions without any date effective relvars. As shown, an employee relation definition 1102 comprises an identifier (ID) 1104, and a single relvar comprising an employee identifier (EmployeeID) relvar 1106. A position relation definition 1112 comprises an identifier (ID) 1114, and a single relvar comprising a position identifier (PositionID) relvar 1116. An employee position relationship relation definition 1122 comprises an identifier (ID) 1124, and two relvars comprising an employee (Employee) 1126-1 and a position (Position) 1126-2. The relation definitions 1102, 1112 and 1122 do not define a relation 142-a having any date effective information 144-b. The employee relation definition 1102, the position relation definition 1112, and the employee position relationship 1122 do not provide any historical (time-based) information for an employee.

The logical diagram 1150 illustrates relation definitions with date effective relvars. As shown, the employee relation definition 1102 and the position relation definition 1112 remain the same as described with reference to the logical diagram 1100. However, the employee position relationship (EmployeePositionRelationship) relation definition 1122 as described with reference to the logical diagram 1100 has been replaced with an employee position relationship (EmployeePositionRelationship) relation definition 1132.

The employee position relationship (EmployeePositionRelationship) relation definition 1132 comprises an identifier (ID) 1134, and four relvars comprising an employee (Employee) relvar 1136-1, a position (Position) relvar 1136-2, a valid from (ValidFrom) relvar 1136-3, and a valid to (ValidTo) relvar 1136-4. The employee position relationship relation definition 1132 does provide historical (time-based) information for an employee.

The employee position relationship relation definition 1132 has an alternate key (AK1) comprising a composite of the employee relvar 1136-1, the position relvar 1136-2, and the valid from relvar 1136-3. This alternate key is a valid time state key that can be used to enforce overlap and gap semantics. This valid time state key allows an employee to have more than one position starting from the same ValidFrom date. Hence an employee is allowed to have multiple positions starting at a same time or even at overlapping periods of time. However, the valid time state key does not allow an employee to have same position twice or more within overlapping periods of time.

Assuming no gap semantics, an employee can have a position and then belong to a separate position with a gap in between. However, this is not considered a true gap since the two rows represent separate relationships as per the valid time state key definition. A true gap is when an employee is not allowed to have a same position with a gap between time periods, and this scenario will result in an exception if the valid time state key does not allow gap conditions.

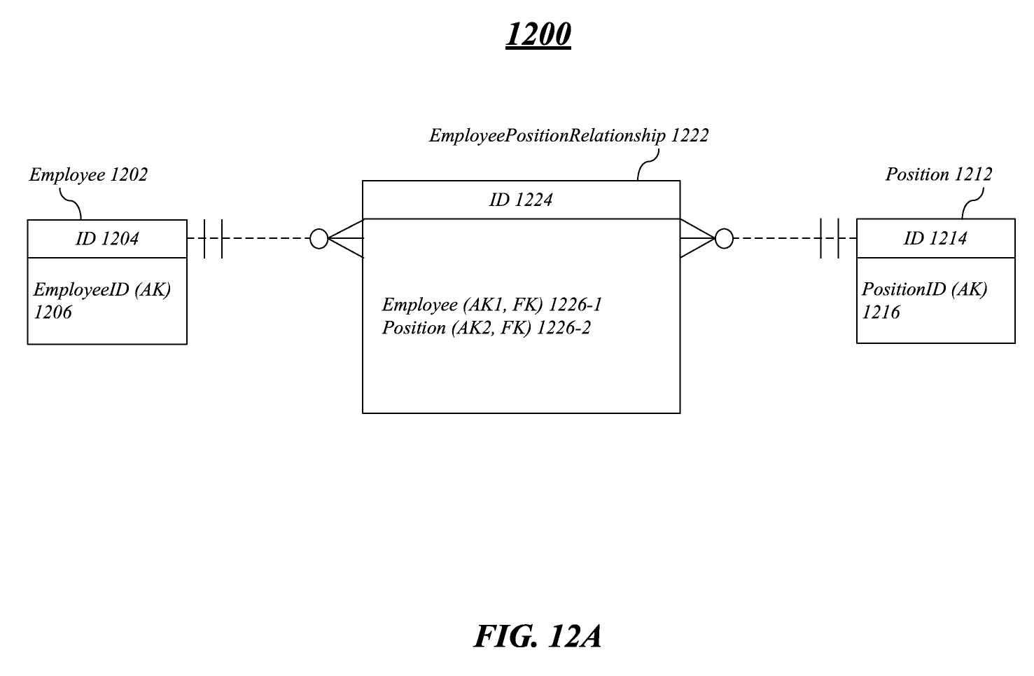

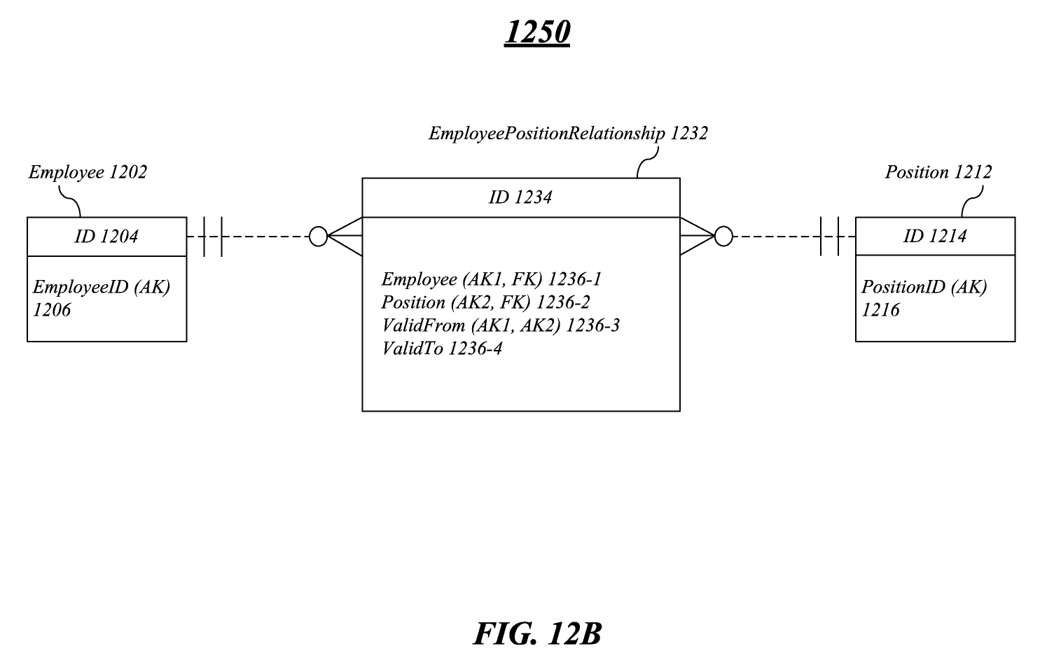

FIGS. 12A, 12B illustrate respective logical diagrams 1200, 1250 of exemplary relational models for the RDBMS 100. The logical diagrams 1200, 1250 may be used to demonstrate a third example of a design for a valid time state key and its role in enforcing date effective semantics.

The logical diagrams 1200, 1250 may illustrate a use scenario for enforcing overlap semantics for a relation 142-a. In this use scenario, assume a human resources manager is tracking histories for a set of employees. Further assume an employee can have zero or a maximum of one position and a position can have zero or a maximum of one employee. In a current database (with no history) this could be represented by the logical diagram 1200.

The logical diagram 1200 illustrates relation definitions without any date effective relvars. As shown, an employee relation definition 1202 comprises an identifier (ID) 1204, and a single relvar comprising an employee identifier (EmployeeID) relvar 1206. A position relation definition 1212 comprises an identifier (ID) 1214, and a single relvar comprising a position identifier (PositionID) relvar 1216. An employee position relationship relation definition 1222 comprises an identifier (ID) 1224, and two relvars comprising an employee (Employee) 1226-1 and a position (Position) 1226-2. The relation definitions 1202, 1212 and 1222 do not define a relation 142-a having any date effective information 144-b. The employee relation definition 1202, the position relation definition 1212, and the employee position relationship 1222 do not provide any historical (time-based) information for an employee.

The logical diagram 1250 illustrates relation definitions with date effective relvars. As shown, the employee relation definition 1202 and the position relation definition 1212 remain the same as described with reference to the logical diagram 1200. However, the employee position relationship (EmployeePositionRelationship) relation definition 1222 as described with reference to the logical diagram 1200 has been replaced with an employee position relationship (EmployeePositionRelationship) relation definition 1232.

The employee position relationship (EmployeePositionRelationship) relation definition 1232 comprises an identifier (ID) 1234, and four relvars comprising an employee (Employee) relvar 1236-1, a position (Position) relvar 1236-2, a valid from (ValidFrom) relvar 1236-3, and a valid to (ValidTo) relvar 1236-4. The employee position relationship relation definition 1232 does provide historical (time-based) information for an employee.

The employee position relationship relation definition 1232 has two alternate keys (AK1, AK2). A first alternate key (AK1) comprises a composite of the employee relvar 1236-1 and the valid from relvar 1236-3. A second alternate key (AK2) comprises a composite of the position relvar 1236-2 and the valid from relvar 1236-3. Both alternate keys AK1, AK2 are considered valid time state keys, and valid time state semantics need to be enforced on both valid time state keys simultaneously.

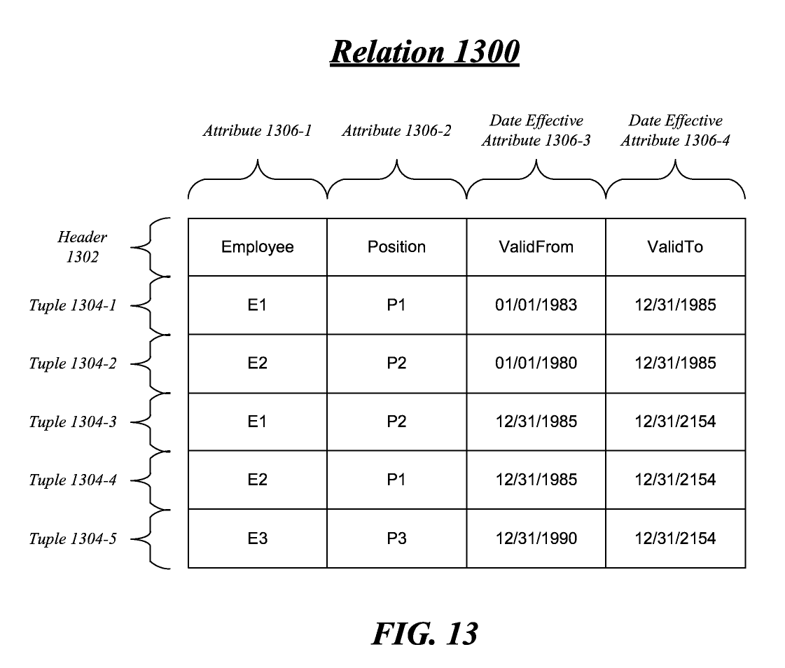

FIG. 13 illustrates a relation 1300 with sample data for the employee position relationship relation definition 1232 described with reference to the logical diagram 1250 of FIG. 12B. As shown, the relation 1300 comprises attributes 1306-1 to 1306-4, with attributes 1306-3, 1306-4 comprising date effective attributes. The relation 1300 further comprises a header 1302 with attribute names for each attribute 1306-1 to 1306-4, including “Employee,” “Position,” “ValidFrom,” and “ValidTo.” In the sample relation values provided for each attribute 1306-1 to 1306-4 of tuples 1304-1 to 1304-5, it is worthy to note that E1 cannot change her position to P2 while E2 is occupying P2. Having multiple valid time state keys expands the number of adjustments that have to be done to account for any change in a date range of existing records. If E1, P2 changes to 1984-01-01 for a ValidFrom date, then ValidTo of E1, P1 and E2, P2 records need to be changed to avoid gaps. Further, a ValidFrom date for the E2, P1 record needs to be changed as well.

If there are more than two valid time state keys, then it becomes more difficult for a user to understand the impact of any changes to valid time state records. In one embodiment, a relation 142-a can be limited to a single valid time state key to enforce valid time state semantics to reduce complexity in user interfaces and user interactions.

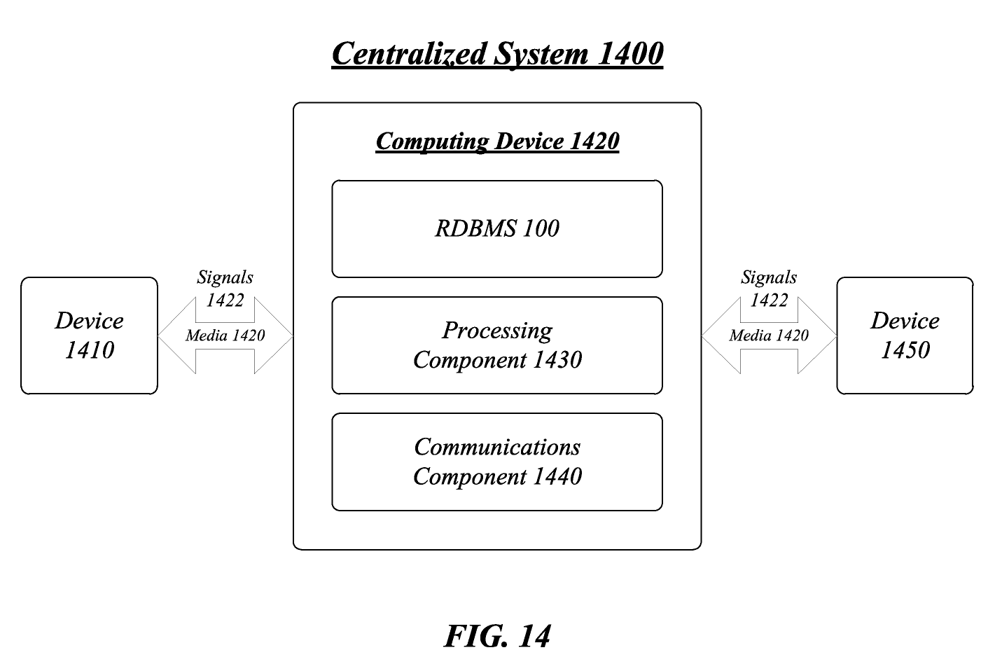

FIG. 14 illustrates a block diagram of a centralized system 1400. The centralized system 1400 may implement some or all of the structure and/or operations for the RDBMS 100 in a single computing entity, such as entirely within a single computing device 1420.

The computing device 1420 may execute processing operations or logic for the RDBMS 100 using a processing component 1430. The processing component 1430 may comprise various hardware elements, software elements, or a combination of both. Examples of hardware elements may include devices, logic devices, components, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The computing device 1420 may execute communications operations or logic for the RDBMS 100 using communications component 1440. The communications component 1440 may implement any well-known communications techniques and protocols, such as techniques suitable for use with packet-switched networks (e.g., public networks such as the Internet, private networks such as an enterprise intranet, and so forth), circuit-switched networks (e.g., the public switched telephone network), or a combination of packet-switched networks and circuit-switched networks (with suitable gateways and translators). The communications component 1440 may include various types of standard communication elements, such as one or more communications interfaces, network interfaces, network interface cards (NIC), radios, wireless transmitters/receivers (transceivers), wired and/or wireless communication media, physical connectors, and so forth. By way of example, and not limitation, communication media 1420 includes wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media 1420. The computing device 1420 may communicate with other devices 1410, 1450 over a communications media 1420 using communications signals 1422 via the communications component 1440.

As previously mentioned, the database application 120 of the RDBMS 100 may generate a database result 130 with date effective information 144-b in response to a database query 110. In one embodiment, the database query 110 may be generated by a commercial line-of-business application. Examples of commercial line-of-business applications may include without limitation an ERP application, a CRM application, a SCM application, and so forth. These commercial line-of-business applications are sometimes referred to as “middle-tier” applications as they are typically executed by servers or server arrays in commercial enterprise networks, rather than client devices such as a desktop computer. A specific example of a commercial line-of-business application may comprise a Microsoft Dynamics® Ax ERP made by Microsoft Corporation, Redmond, Wash. However, the embodiments are not limited to this example.

A commercial line-of-business application implemented by one or more devices 1410, 1450 may generate a database query 110 to retrieve date effective information 144-b from the RDBMS 100 implemented by the computing device 1420. The database query 110 may comprise any query generated in accordance with any defined query language. In one embodiment, for example, a database query 110 may comprise a structured query language (SQL) query. In one embodiment, for example, a database query 110 may comprise a transact structured query language (T-SQL) query. Other query languages may be supported as well.

To support data retrieval, a commercial line-of-business application may implement business application logic written in a suitable programming language used to develop the commercial line-of-business application. For instance, for a Microsoft Dynamics Ax ERP application, business application logic can be written in an X++ language to retrieve the data stored in a relation 142-a for further processing. To facilitate this retrieval, the RDBMS 100 is designed to support at least three modes of data retrieval in accordance with three different types of database queries.

In one embodiment, a database query 110 may comprise a current query. A current query is a query arranged to retrieve date effective information corresponding to a current date value, a current time value, or a current date and time value. This type of query will retrieve data from a relation 142-a and return a record that is currently active as of the current date value, current time value, or current date and time value.

In one embodiment, the database query 110 may comprise a date query. A data query is a query arranged to retrieve date effective information corresponding to a date value, a time value, or a date and time value specified by the date query 100. This type of query will retrieve a record that is valid on the passed in date value or date/time value. This can be a past value, a current value, or a future value. In the case of a passed date value, the ValidFrom date of the retrieved record will be less than or equal to the passed in value, and the ValidTo date will be greater than or equal to the passed in value.

In one embodiment, the database query 110 may comprise a date range query. A date range query is a query arranged to retrieve date effective information corresponding to a range of date values, time values, or date and time values specified by the date query 110. This type of query will return records that are valid for the passed in range of date values or date/time values. The passed in range of values can also comprise past values, current values, future values, or some combination thereof. In the case of a passed date values, the ValidFrom date of the retrieved record will be less than or equal to the passed in value, and the ValidTo date will be greater than or equal to the passed in value.

Any database query language may be modified to support a valid time state key semantics. For instance, the X++ language supports a syntax that is similar to the TSQL syntax that is used when querying relational databases. The RDBMS 100 enhances this syntax by adding a “validtimestate” keyword to indicate a type of query. This enhancement translates to the following queries:
1. Select * from EmployeeEmergencyContact where Employee==‘A.’ This query will retrieve the current emergency contact information for Employee A. It is worthy to note that this query did not need to specify any additional predicates in the “where” clause as it is automatically added by the data access component 124 at runtime.
2. Select validtimestate (Apr. 21, 1986)* from EmployeeEmergencyContact where Employee==‘A.’ This query will retrieve the record that is in effect on Apr. 21, 1986.
3. Select validtimestate (01/01/1985, 12/31/9999) where Employee==‘A.’ This query will retrieve all the records for Employee A for the passed in time period (01/01/1985, 12/31/9999).
   It is worthy to note that date/time values can be used in the above examples if the ValidFrom and ValidTo attributes (columns) are of a data type of DateTime.

A database query 110 may be generated by an application utilizing one or more query APIs. Any database query language may be modified to support a valid time state key semantics by exposing suitable query APIs. For instance, the X++ language also exposes a query API to retrieve data from one or more relations 142-a. This query API can be extended by various methods to allow different forms of date effective querying. Some exemplary APIs may include, without limitation, the following:
1. ValidTimeStateAsOfDate (date);
2. ValidTimeStateAsOfDateTime (datetime);
3. ValidTimeStateDateRange (date); and
4. ValidTimeStateDateTimeRange (datetime).
   The database application 120 may take the above queries and transform them by additional predicates on ValidFrom and ValidTo attributes to fetch data elements that match the query.

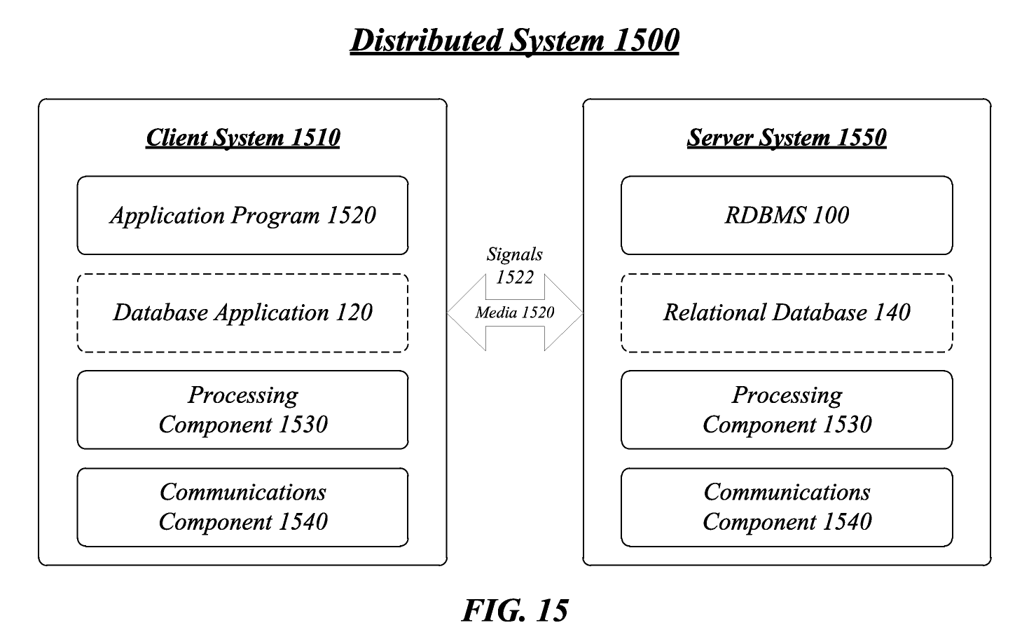

FIG. 15 illustrates a block diagram of a distributed system 1500. The distributed system 1500 may distribute portions of the structure and/or operations for the system 100 across multiple computing entities. Examples of distributed system 1500 may include without limitation a client-server architecture, a 3-tier architecture, an N-tier architecture, a tightly-coupled or clustered architecture, a peer-to-peer architecture, a master-slave architecture, a shared database architecture, and other types of distributed systems. The embodiments are not limited in this context.

The client system 1510 and the server system 1550 may process information using the processing components 1530, which are similar to the processing component 1430 described with reference to FIG. 14. The client system 1510 and the server system 1550 may communicate with each over a communications media 1520 using communications signals 1522 via communications components 1540, which are similar to the communications component 1440 described with reference to FIG. 14.

In various embodiments, the client system 1510 may comprise or employ one or more client computing devices and/or client programs that operate to perform various methodologies in accordance with the described embodiments. In one embodiment, the client system 1510 may implement an application program 1520. The application program 1520 may comprise a commercial line-of-business application. Examples of commercial line-of-business applications may include without limitation an ERP application, a CRM application, a SCM application, and so forth. In one embodiment, for example, the commercial line-of-business application may be implemented as a Microsoft Dynamics Ax ERP. Additionally or alternatively, the client system 1510 may implement various web technologies, such as a web browser, web application or web service. The client system 1510 may access the RDBMS 100 via the various web technologies. For instance, a user may access the RDBMS 100 via a web browser (not shown) implemented by the client system 1510 to manage, retrieve or otherwise access relational data stored by the RDBMS 100.

In various embodiments, the server system 1550 may comprise or employ one or more server computing devices and/or server programs that operate to perform various methodologies in accordance with the described embodiments. For example, when installed and/or deployed, a server program may support one or more server roles of the server computing device for providing certain services and features. Exemplary server systems 1530 may include, for example, stand-alone and enterprise-class server computers operating a server OS such as a MICROSOFT® OS, a UNIX® OS, a LINUX® OS, or other suitable server-based OS. Exemplary server programs may include, for example, communications server programs such as Microsoft® Office Communications Server (OCS) for managing incoming and outgoing messages, messaging server programs such as Microsoft® Exchange Server for providing unified messaging (UM) for e-mail, voicemail, VoIP, instant messaging (1M), group IM, enhanced presence, and audio-video conferencing, and/or other types of programs, applications, or services in accordance with the described embodiments.

In one embodiment, the distributed system 1500 may be implemented as a client-server system. For example, the client system 1510 may implement the application program 1520, and the server system 1550 may implement the RDBMS 100. Alternatively, the client system 1510 may optionally implement a portion of the RDBMS 100, such as the database application 120, and the server system 1550 may optionally implement another portion of the RDBMS 100, such as the relational database 140. The embodiments are not limited in this context.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

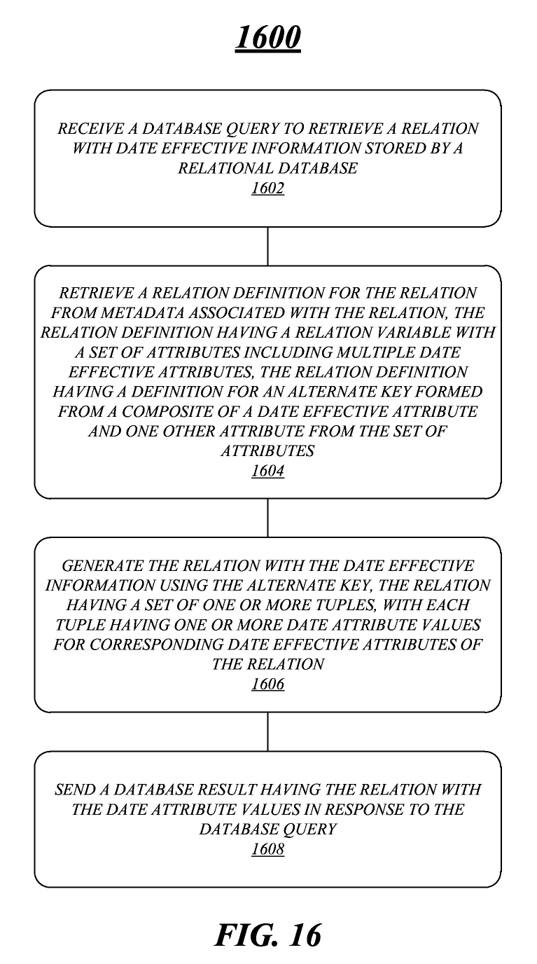

FIG. 16 illustrates one embodiment of a logic flow 1600. The logic flow 16200 may be representative of some or all of the operations executed by one or more embodiments described herein.

In the illustrated embodiment shown in FIG. 16, the logic flow 1600 may receive a database query to retrieve a relation with date effective information stored by a relational database at block 1602. For example, the data mapping component 122 of the database application 120 may receive a database query 110 to retrieve a relation 142-1 with date effective information 144-1 stored by the relational database 140. The database query 110 may comprise, for example, an SQL or TSQL query generated by a select statement or an API from an application program 1520. The embodiments are not limited to this example.

The logic flow 1600 may retrieve a relation definition for the relation from metadata associated with the relation, the relation definition having a relation variable with a set of attributes including multiple date effective attributes, the relation definition having a definition for an alternate key formed from a composite of a date effective attribute and one other attribute from the set of attributes at block 1604. For example, the data mapping component 122 may retrieve a relation definition 146-1 for the relation 142-1 from metadata 148-1 associated with the relation 142-1. The relation definition 146-1 may have a relation variable 216-1 with a set of attributes 306-1 to 306-5 including multiple date effective attributes 306-4, 306-5. The relation definition 146-1 may also have a definition for an alternate key (AK) formed from a composite of a date effective attribute 306-4, 306-5 (e.g., a ValidFrom attribute), and one other attribute from the set of attributes 306-1, 306-2 or 306-3 (e.g., an Employee attribute). The alternate key may comprise, for example, a valid time state key. The embodiments are not limited to this example.

The logic flow 1600 may generate the relation with the date effective information using the alternate key, the relation having a set of one or more tuples, with each tuple having one or more date attribute values for corresponding date effective attributes of the relation at block 1606. For example, the data access component 124 may receive the relation definition 146-1 from the data mapping component 122, and generate the relation 142-1 with the date effective information 144-1 using the alternate key (e.g., the valid time state key). The relation 142-1 may have a set of one or more tuples 304-e, with each tuple having one or more date attribute values 310-z for corresponding date effective attributes 306-4, 306-5 of the relation 142-1. The date attribute values 310-z may comprise, for example, date values, time values, or date and time values. The embodiments are not limited to this example.

The logic flow 1600 may send a database result having the relation with the date attribute values in response to the database query at block 1608. For example, the data access component 124 may return a database result 130 having the relation 142-1 with the date attribute values 310-z in response to the database query 110. The embodiments are not limited to this example.

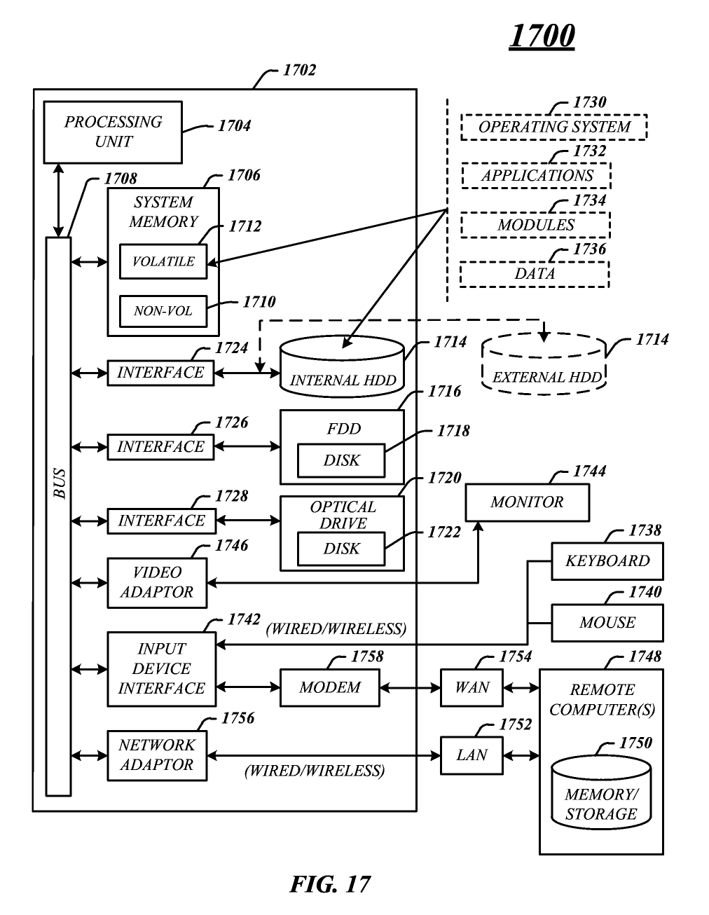

FIG. 17 illustrates an embodiment of an exemplary computing architecture 1700 suitable for implementing various embodiments as previously described. As used in this application, the terms “system” and “component” are intended to refer to a computer-related entity, either hardware, a combination of hardware and software, software, or software in execution, examples of which are provided by the exemplary computing architecture 1700. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

In one embodiment, the computing architecture 1700 may comprise or be implemented as part of an electronic device. Examples of an electronic device may include without limitation a mobile device, a personal digital assistant, a mobile computing device, a smart phone, a cellular telephone, a handset, a one-way pager, a two-way pager, a messaging device, a computer, a personal computer (PC), a desktop computer, a laptop computer, a notebook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combination thereof. The embodiments are not limited in this context.

The computing architecture 1700 includes various common computing elements, such as one or more processors, co-processors, memory units, chipsets, controllers, peripherals, interfaces, oscillators, timing devices, video cards, audio cards, multimedia input/output (I/O) components, and so forth. The embodiments, however, are not limited to implementation by the computing architecture 1700.

As shown in FIG. 17, the computing architecture 1700 comprises a processing unit 1704, a system memory 1706 and a system bus 1708. The processing unit 1704 can be any of various commercially available processors. Dual microprocessors and other multi-processor architectures may also be employed as the processing unit 1704. The system bus 1708 provides an interface for system components including, but not limited to, the system memory 1706 to the processing unit 1704. The system bus 1708 can be any of several types of bus structure that may further interconnect to a memory bus (with or without a memory controller), a peripheral bus, and a local bus using any of a variety of commercially available bus architectures.

The computing architecture 1700 may comprise or implement various articles of manufacture. An article of manufacture may comprise a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like.

The system memory 1706 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. In the illustrated embodiment shown in FIG. 17, the system memory 1706 can include non-volatile memory 1710 and/or volatile memory 1712. A basic input/output system (BIOS) can be stored in the non-volatile memory 1710.

The computer 1702 may include various types of computer-readable storage media in the form of one or more lower speed memory units, including an internal hard disk drive (HDD) 1714, a magnetic floppy disk drive (FDD) 1716 to read from or write to a removable magnetic disk 1718, and an optical disk drive 1720 to read from or write to a removable optical disk 1722 (e.g., a CD-ROM or DVD). The HDD 1714, FDD 1716 and optical disk drive 1720 can be connected to the system bus 1708 by a HDD interface 1724, an FDD interface 1726 and an optical drive interface 1728, respectively. The HDD interface 1724 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 1710, 1712, including an operating system 1730, one or more application programs 1732, other program modules 1734, and program data 1736.

The one or more application programs 1732, other program modules 1734, and program data 1736 can include, for example, the RDBMS 100, the database application 120, the data mapping component 122, the data access component 124, the data model component 126, and so forth.

A user can enter commands and information into the computer 1702 through one or more wire/wireless input devices, for example, a keyboard 1738 and a pointing device, such as a mouse 1740. Other input devices may include a microphone, an infra-red (IR) remote control, a joystick, a game pad, a stylus pen, touch screen, or the like. These and other input devices are often connected to the processing unit 1704 through an input device interface 1742 that is coupled to the system bus 1708, but can be connected by other interfaces such as a parallel port, IEEE 1394 serial port, a game port, a USB port, an IR interface, and so forth.

A monitor 1744 or other type of display device is also connected to the system bus 1708 via an interface, such as a video adaptor 1746. In addition to the monitor 1744, a computer typically includes other peripheral output devices, such as speakers, printers, and so forth.

The computer 1702 may operate in a networked environment using logical connections via wire and/or wireless communications to one or more remote computers, such as a remote computer 1748. The remote computer 1748 can be a workstation, a server computer, a router, a personal computer, portable computer, microprocessor-based entertainment appliance, a peer device or other common network node, and typically includes many or all of the elements described relative to the computer 1702, although, for purposes of brevity, only a memory/storage device 1750 is illustrated. The logical connections depicted include wire/wireless connectivity to a local area network (LAN) 1752 and/or larger networks, for example, a wide area network (WAN) 1754. Such LAN and WAN networking environments are commonplace in offices and companies, and facilitate enterprise-wide computer networks, such as intranets, all of which may connect to a global communications network, for example, the Internet.

When used in a LAN networking environment, the computer 1702 is connected to the LAN 1752 through a wire and/or wireless communication network interface or adaptor 1756. The adaptor 1756 can facilitate wire and/or wireless communications to the LAN 1752, which may also include a wireless access point disposed thereon for communicating with the wireless functionality of the adaptor 1756.

When used in a WAN networking environment, the computer 1702 can include a modem 1758, or is connected to a communications server on the WAN 1754, or has other means for establishing communications over the WAN 1754, such as by way of the Internet. The modem 1758, which can be internal or external and a wire and/or wireless device, connects to the system bus 1708 via the input device interface 1742. In a networked environment, program modules depicted relative to the computer 1702, or portions thereof, can be stored in the remote memory/storage device 1750. It will be appreciated that the network connections shown are exemplary and other means of establishing a communications link between the computers can be used.

The computer 1702 is operable to communicate with wire and wireless devices or entities using the IEEE 802 family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity), WiMax, and Bluetooth™ wireless technologies. Thus, the communication can be a predefined structure as with a conventional network or simply an ad hoc communication between at least two devices. Wi-Fi networks use radio technologies called IEEE 802.11x (a, b, g, n, etc.) to provide secure, reliable, fast wireless connectivity. A Wi-Fi network can be used to connect computers to each other, to the Internet, and to wire networks (which use IEEE 802.3-related media and functions).

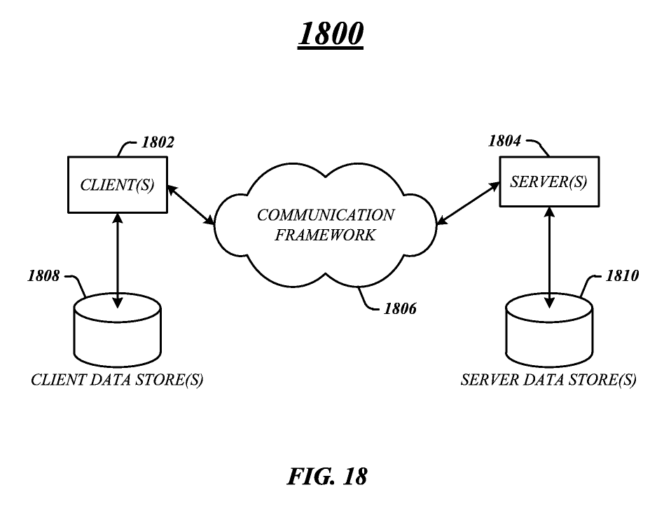

FIG. 18 illustrates a block diagram of an exemplary communications architecture 1800 suitable for implementing various embodiments as previously described. The communications architecture 1800 includes various common communications elements, such as a transmitter, receiver, transceiver, radio, network interface, baseband processor, antenna, amplifiers, filters, and so forth. The embodiments, however, are not limited to implementation by the communications architecture 1800.

As shown in FIG. 18, the communications architecture 1800 comprises includes one or more clients 1802 and servers 1804. The clients 1802 may implement the client systems 310, 400. The servers 1804 may implement the server system 330. The clients 1802 and the servers 1804 are operatively connected to one or more respective client data stores 1808 and server data stores 1810 that can be employed to store information local to the respective clients 1802 and servers 1804, such as cookies and/or associated contextual information.

The clients 1802 and the servers 1804 may communicate information between each other using a communication framework 1806. The communications framework 1806 may implement any well-known communications techniques and protocols, such as those described with reference to the RDBMS 100. The communications framework 1806 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

Some embodiments may be described as comprising one or more elements. For instance, some elements may have labels containing variables such as “a” and “b” and “c” and similar designators. It is worthy to note that such designators are intended to be variables representing any positive integer. Thus, for example, if an implementation sets a value for a=5, then a complete set of elements 101-a may include elements 101-1, 101-2, 101-3, 101-4 and 101-5. The embodiments are not limited in this context.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

1. A computer-implemented method, comprising:
receiving a database query to retrieve a relation with date effective information stored by a relational database;
retrieving a relation definition for the relation from metadata associated with the relation, the relation definition having a relation variable with a set of attributes including multiple date effective attributes, the relation definition having a definition for an alternate key formed from a composite of a date effective attribute and one other attribute from the set of attributes;
generating the relation with the date effective information using the alternate key, the relation having a set of one or more tuples, with each tuple having one or more date attribute values for corresponding date effective attributes of the relation; and
sending a database result having the relation with the date attribute values in response to the database query.

2. The computer-implemented method of claim 1, comprising receiving the database query as a structured query language query or a transact structured query language query.

3. The computer-implemented method of claim 1, comprising receiving the database query from a query application program interface.

4. The computer-implemented method of claim 1, comprising receiving the database query to retrieve information from the relational database, the database query comprising a current query to retrieve date effective information corresponding to a current date value, a current time value, or a current date and time value.

5. The computer-implemented method of claim 1, comprising receiving the database query to retrieve information from the relational database, the database query comprising a date query to retrieve date effective information corresponding to a date value, a time value, or a date and time value as specified by the date query.

6. The computer-implemented method of claim 1, comprising receiving the database query to retrieve information from the relational database, the database query comprising a date range query to retrieve date effective information corresponding to a range of date values, time values, or date and time values as specified by the date range query.

7. The computer-implemented method of claim 1, comprising retrieving the relation definition for the relation from metadata associated with the relation, the relation definition having a relation variable with a set of attributes including multiple date effective attributes including a valid from attribute and a valid to attribute, the relation definition having a definition for an alternate key formed from a composite of the valid from attribute and one other attribute from the set of attributes.

8. The computer-implemented method of claim 1, comprising modifying the date effective information for the relation stored by the relational database in accordance with the relation definition.

9. The computer-implemented method of claim 1, comprising modifying the date effective information for the relation stored by the relational database in accordance with one or more update modes, including a correction mode, a new time mode, or an effective based mode.

10. The computer-implemented method of claim 1, comprising modifying the date effective information for the relation stored by the relational database in accordance with one or more update conditions, including an overlap condition or a gap condition.

11. An article of manufacture comprising a storage medium containing instructions that when executed enable a system to:
retrieve a relation definition for a relation from metadata associated with the relation, the relation definition having a relation variable with a set of attributes including multiple date effective attributes, the relation definition having a definition for an alternate key formed from a composite of a date effective attribute and one other attribute from the set of attributes; and
generate a relation with date effective information using the alternate key, the relation having a set of one or more tuples, with each tuple having one or more attribute values for corresponding date effective attributes of the relation.

12. The article of manufacture of claim 11, further comprising instructions that when executed enable the system to retrieve the relation definition in response to a database query, the database query comprising one of:
a current query arranged to retrieve date effective information corresponding to a current date value, a current time value, or a current date and time value;
a date query arranged to retrieve date effective information corresponding to a date value, time value, or date and time value as specified by the date query; or
a date range query arranged to retrieve date effective information corresponding to a range of date values, time values, or date and time values as specified by the date range query.

13. The article of manufacture of claim 11, further comprising instructions that when executed enable the system to modify the date effective information for the relation stored by the relational database in accordance with the relation definition.

14. The article of manufacture of claim 11, further comprising instructions that when executed enable the system to modify the date effective information for the relation stored by the relational database in accordance with one or more update modes, including a correction mode, a new time mode, or an effective based mode.

15. The article of manufacture of claim 11, further comprising instructions that when executed enable the system to modify the date effective information for the relation stored by the relational database in accordance with one or more update conditions, including an overlap condition or a gap condition.

16. An apparatus, comprising:
a logic device; and
a database application operative on the logic device to receive a database query to retrieve a relation with date effective information stored by a relational database and send a database result having the date effective information in response to the database query, the database application comprising:
a data mapping component operative to retrieve a relation definition for the relation from metadata associated with the relation, the relation definition having a relation variable with a set of attributes including multiple date effective attributes, the relation definition having a definition for an alternate key formed from a composite of a date effective attribute and one other attribute from the set of attributes; and
a data access component operative to generate the relation with the date effective information using the alternate key, the relation having a set of one or more tuples, with each tuple having one or more attribute values for corresponding date effective attributes of the relation.

17. The apparatus of claim 16, comprising a data model component operative to define the relation definition for the relation prior to storage with the metadata for the relation, the relation definition having a relation variable with a set of attributes including multiple date effective attributes including a valid from attribute and a valid to attribute, the relation definition having a definition for an alternate key formed from a composite of the valid from attribute and one other attribute from the set of attributes.

18. The apparatus of claim 16, the database query comprising a structured query language query or a transact structured query language query.

19. The apparatus of claim 16, the database application receiving the database query from a query application program interface.

20. The apparatus of claim 16, the database query comprising:
a current query arranged to retrieve date effective information corresponding to a current date value, a current time value, or a current date and time value;
a date query arranged to retrieve date effective information corresponding to a date value, time value, or date and time value as specified by the date query; or
a date range query arranged to retrieve date effective information corresponding to a range of date values, time values, or date and time values as specified by the date range query.
